(19) United States
(12) Patent Application Publication
(10) Pub. No.: US 2009/0017800 A1
(43) Pub. Date: Jan. 15, 2009

(54) FM TRANSMITTER CONTROL

(76) Inventor: Don Middleton, Delta (CA)

Correspondence Address: HAYNES AND BOONE, LLP;IP Section, 2323 Victory Avenue, Suite 700, Dallas, TX, 75219, US

(21) Appl. No.: 11/913,764

(22) PCT Filed: May 3, 2006
(86) PCT No.: PCT/IB06/01627

§ 371 Date: May 6, 2008

(30) Foreign Application Priority Data
May 6, 2005 (GB) 0509259.7

(51) Int. Cl. H04Q 7/38

(52) U.S. Cl. 455/414.1

(57) ABSTRACT

Disclosed is a method for adaptively controlling transmission of FM signals from an electronic device such as a mobile phone handset. In one embodiment, the geographical location of the handset is determined. Based on the location of the handset, it is checked whether in this location, the FM transmissions are allowed or not. If the FM transmissions are allowed, the handset can start an FM transmission. However, if in this location the FM transmissions are not permitted, then the processing unit of the handset is informed that FM transmissions are not allowed and the FM transmissions are disabled. Also a specific message can be shown on the display of the handset.

### FIELD OF THE INVENTION

The invention relates to FM transmissions and more specifically controlling such transmissions when a transmitter is in a certain geographical location. The invention also relates to a corresponding terminal, system, module, software code and software computer product.

### BACKGROUND OF THE INVENTION

Frequency modulation (FM) is a form of modulation in which information is represented as variations in the instantaneous frequency of a carrier wave. In 1936, Edwin Armstrong of Columbia University presented a paper describing an FM radio system entitled “A Method of Reducing Disturbances in Radio Signaling by a System of Frequency Modulation”.

FM is commonly used at the very high frequency (VHF) band for radio broadcasts of speech and music. The VHF band extends from about 30 to about 300 MHz in the electromagnetic spectrum, although in most countries commercial FM radio broadcasts operate on a frequency range from 88 MHz to 108 MHz. The VHF band is well suited to local radio transmissions since the ionosphere does not usually reflect VHF waves and thus transmissions are restricted to the local area.

Currently there is a trend to combine multiple features into mobile phone handsets. Samsung Electronics Co. Ltd. of Seoul, South Korea recently unveiled a mobile phone with an internal 1.6 GB hard drive. The Samsung SPH-V5400 mobile phone was launched at the ITU Telecom Asia exhibition in September 2004. The Samsung SPH-V5400 mobile phone also includes an FM transmitter so that the user can play music from the phone on a nearby radio receiver.

By incorporating an FM transmitter into a mobile phone, it is possible to transmit audio signals, such as music or speech, to another device via the FM transmitter. These audio signals can then be played on another device, such as a home stereo system. Home stereo players can typically play the music with much better sound quality than mobile phone handsets. Therefore, while listening to music on a handset can be good, if the music can be transmitted to, for example, a car or home stereo system, then the sound quality can be improved.

Transferring audio between devices using FM transmissions makes it possible to transfer signals wirelessly without the need for any wires or cables. The only requirements for transferring audio signals between handsets using FM transmissions are that the handset includes an FM transmitter and the receiving device includes an FM receiver.

Some countries like the USA permit the use of low power FM radio band transmitters to send music and voice to FM receivers. Such low power transmissions may propagate a few tens of meters when no obstructions are on the propagation path of the signal. Some other countries, particularly in Europe, currently have legislation that requires individuals to have a license for FM transmissions. A problem arises when a user of a mobile phone handset incorporating such an FM transmitter travels for example from the USA to Europe and starts to use the FM transmitter. Currently, there is no way for a user to know whether FM transmissions are allowed unless the user is aware of the current legislation. Thus, the user may inadvertedly start FM transmissions in a country where a license is needed by using their handset for FM transmissions.

### SUMMARY OF THE INVENTION

The applicant has recognised that there is a need to control FM transmissions when the user is in a geographical area where FM transmissions by individuals are not allowed.

According to a first aspect of the invention there is provided a method for transmitting FM radio signals from a portable device the method comprising: detecting geographical location of the portable device, and determining if FM transmissions are allowed or not in the detected location.

The method in accordance with the invention has an advantage that FM transmitters installed into portable devices can be automatically disabled in countries prohibiting such activities. Thus an advantage of using the methods according to the embodiments of this invention is that the user of the portable device can safely travel between countries with different FM transmissions legislations.

The method may further comprise alerting the user whether the FM transmissions are allowed or not in the detected location.

The method may further comprise disabling the FM transmissions if in the current location the FM transmissions are not allowed.

According to a second aspect of the invention there is provided a module for detecting whether FM transmissions are allowed, wherein said module comprises means for detecting a geographical location of the portable device and a lookup table containing information on the allowability of FM transmissions in different geographical locations.

According to a third aspect of the invention there is provided a portable device comprising a module according the second aspect of the invention. The portable device further comprises an FM transmitter adapted to transmit FM signals.

According to a fourth aspect of the invention there is provided a system comprising a terminal capable of transmitting FM signals and a device, which is capable of receiving FM signals wherein said terminal comprises means for: detecting the geographical location of the FM transmitter; determining whether FM transmissions are allowed in the current location.

According to a fifth aspect of the invention there is provided a software code for implementing the method of the invention.

According to a sixth aspect of the invention there is provided a software program product in which a software code in accordance with the invention is stored.

### BRIEF DESCRIPTION OF THE FIGURES

Other features of the present invention will become apparent from the following detailed description when considered in conjunction with the accompanying drawings, in which:

FIG. 1 illustrates a first device communicating via an FM radio link to a second device;

FIG. 2 is a flow chart illustrating a method according to an embodiment in accordance with the invention;

FIG. 3 is a block diagram illustrating a wireless terminal comprising an FM transmitter according to an embodiment of the invention;

FIG. 4 illustrates a second embodiment of the invention;

FIG. 5 illustrates a country database.

### DETAILED DESCRIPTION OF EMBODIMENTS OF THE INVENTION

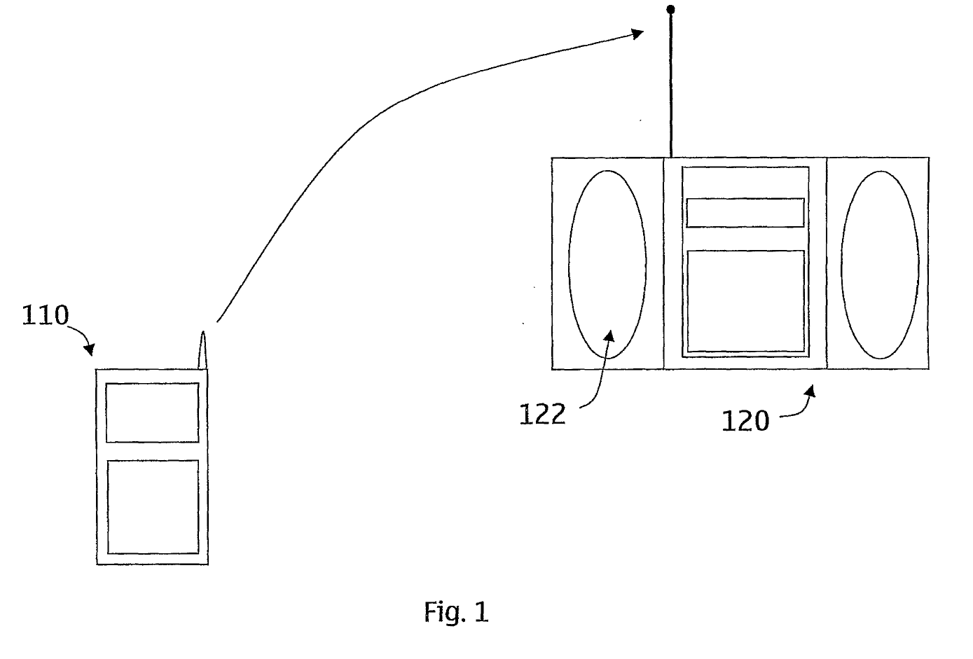

FIG. 1 illustrates an operational environment in which embodiments of the present invention may exist. Specifically, in FIG. 1, there is shown a portable electronic device 110, in this case a mobile phone handset, which includes FM transmission capabilities. The portable electronic device 110 could also be a dedicated portable music player or personal digital assistant (PDA). Alternatively, the electronic device 110 could be permanently installed into a car, in which case the electronic device would move as the car moves.

FIG. 1 also shows a second electronic device 120, in this case a home stereo system. The second electronic device 120 could also be any other electronic device having a capability of receiving FM signals. The electronic device 120 could also be for instance a car stereo or another mobile phone handset with an FM receiver.

The mobile phone handset 110 uses FM transmissions in order to transmit an audio signal, for example music, to the home stereo system 120. Alternatively, other types of audio signals could be transmitted instead of music, for example speech or any other sound. The home stereo system 120 receives music transmitted by the FM transmitter of the mobile phone handset 110, and outputs music as audible sound via the speakers 122. Therefore, instead of listening to music from the mobile phone handset 110, the user of the mobile phone handset 110 can instead send music to the home stereo system 120. Accordingly, it is possible for the user to listen to music with better sound quality than if the music was played through the mobile phone handset 110. No cables or wires are needed when transmitting music. In order to listen to music on the home stereo system 120, the user of the mobile phone handset 110 activates the FM transmission function and then tunes the home stereo system 120 to receive at the same frequency as the mobile phone handset is transmitting.

However, as explained in the background, in certain places FM transmissions are not permitted unless the user has a license. The mobile phone handset 110 addresses this issue by adaptively controlling transmission of FM signals. Thus, the inadvertent transmissions of FM signals can be prevented in places where FM transmissions without a license are not permitted. Alternatively or additionally, a warning message could be shown to the user of the mobile phone handset 110 indicating that FM transmissions are not allowed in certain locations.

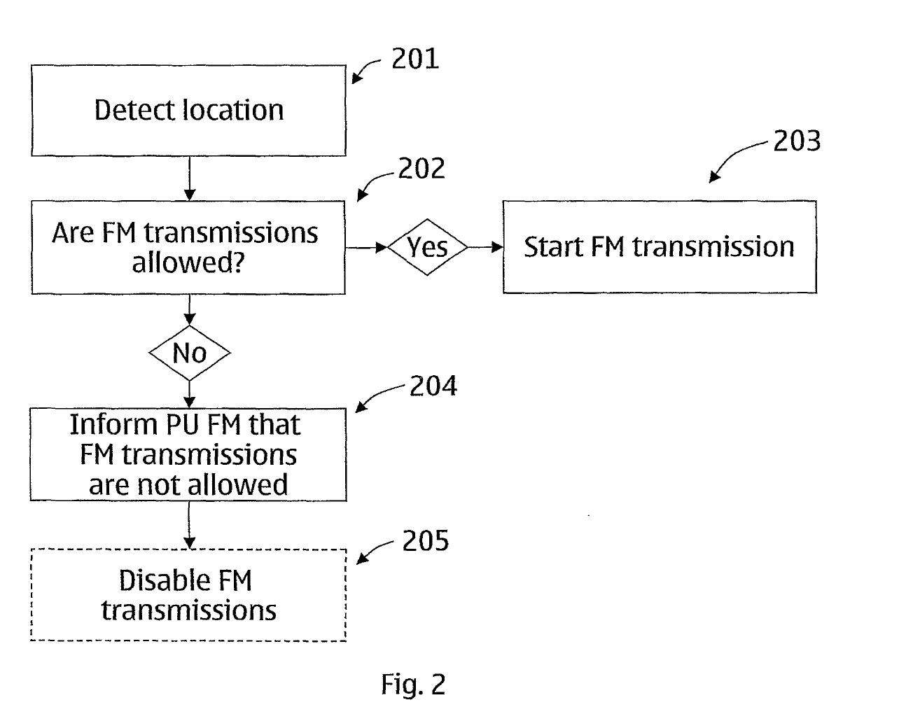

FIG. 2 illustrates a method for adaptively controlling the transmission of FM signals from an electronic device such as a mobile phone handset. In general, at step 201, the geographical location of the handset 110 is detected. At step 202, based on the location of the handset 110, it is determined whether in this location, the FM transmissions are allowed or not. If the FM transmissions are allowed, the handset can start an FM transmission 203. However, if in this location the FM transmissions are not permitted, then at step 204, the processing unit of the handset 110 is informed that FM transmissions are not allowed. This could also mean that a specific message is shown on the display of the handset 110. At step 205, the FM transmissions are disabled. Step 205 is optional since in case the user of the handset 110 is clearly informed that the FM transmissions are not allowed, then it may not be necessary to disable the FM transmissions, but instead the onus of using the FM transmissions is left for the user of the handset 110.

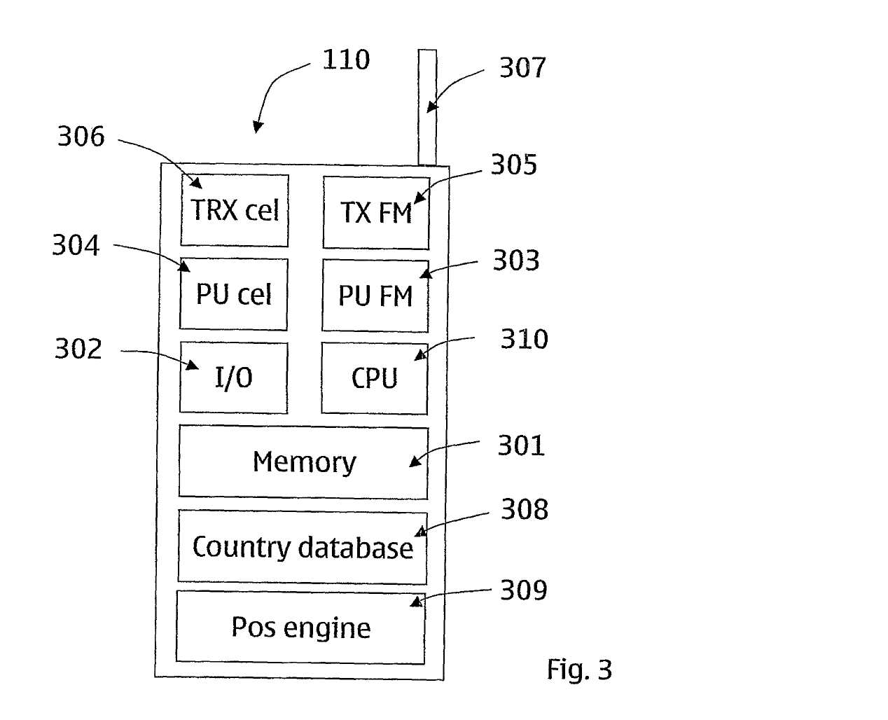

FIG. 3 is a block diagram of the mobile phone handset 110 of FIG. 1. The handset 110 functions as a cellular telephone according to, for example, one or many of the following standards: GSM, GPRS, EDGE, HSCSD, UMTS, CDMA 2000, IS95, etc. The handset 110 also comprises a memory 301. The memory may have random access (RAM) and read only memory (ROM) parts. Suitable data can be stored in that memory. Furthermore, handset 110 contains input/output (I/O) means 302. Input means may be for instance a keyboard but it can also be a touch pad or a touch screen. A microphone may also be provided as an input means for receiving voice information. Output means may be provided for instance by a display, such as a liquid crystal display (LCD). A loudspeaker may also be provided as an output means for outputting speech or sound. Other suitable input/output means are also possible.

The handset 110 also includes an FM transmitter 305 (TX FM) and a cellular transceiver unit 306 (TRX cel). TX FM 305 and TRX cel 306 could also be combined into a single unit sharing a common circuitry. For receiving and transmitting signals, the handset 110 includes an antenna 307. Two or more separate antennas could also be used, but in this embodiment the same antenna can receive and transmit FM and cellular signals.

The handset 110 also includes a processing unit 304 (PU cel) for controlling the cellular transceiver unit 306 (TRX cel), and a processing unit 303 (PU FM) for controlling the FM transmitter 305 (TX FM). The cellular processing unit 304 (PU cel) includes one or more cellular engines depending on the cellular standards supported by the handset. The handset 110 also includes a central processing unit 310 (CPU) for controlling centrally functioning of the handset 110. Each processing unit includes at least one processor for processing data. These processing units may also be combined into a single processor. The processing units are each connected directly or indirectly to the memory unit and the I/O means. According to the present embodiment, the handset 110 also includes a country database 308 and a positioning engine 309 (pos engine), which will be described in more detail below.

The operation of the handset 110 of FIG. 3 will now be described in more detail with reference to the flow chart of FIG. 2. At step 201 the handset 110 detects its geographical location. According to a first embodiment, the handset detects its location by itself by using the positioning engine 309. The location of the handset 110 can be defined for instance by checking the current cell ID. This is possible because each cell in a cellular system has got a unique code, known as cell ID, which is used to identify the current cell. Also carrier code can be used to identify the current country, where the handset 110 is located. Carrier code can be used because carriers tend to be nation specific. Also a satellite positioning engine could be used to define the current location. Examples of such engines are global positioning system (GPS), European alternative Galileo or Russian GLONASS. Using satellite positioning system requires that the handset 110 has got sufficient means for performing satellite positioning. Using satellite positioning would make it possible to achieve accuracy of better than 10 metres. Furthermore, some WLAN based location detection means may be used, as well any other suitable means for detecting location.

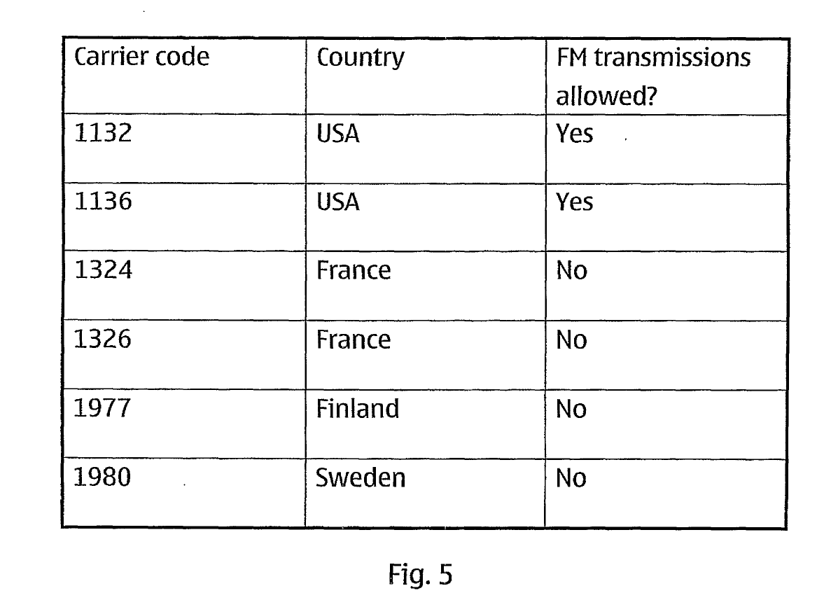

When the current location of the handset 110 is known, it is possible to identify a look-up list of countries where FM transmissions are permissible, and then to map that to the carrier or cell ID. FIG. 5 represents a country database 308, which is a look-up table. The country database 308 can be used in defining whether FM transmissions are allowed in the current location of the handset 110. First column of the country database 308 defines the carrier code, second column defines the corresponding country and the last column tells whether FM transmissions are allowed or not. If the cell ID is used for defining the location of the handset 110, the first column defines the cell ID. If satellite positioning is used for defining the location, the first column is not needed.

When in a home carrier area or roaming, the handset 110 can look at the carrier code or cell ID and map it to a country and then to a definition of whether FM transmissions are permitted or not 202. The country database table 308 is partially available in different forms, but would need assembly during development to incorporate into the handset 110. Alternatively, software code of the country database 308 could be downloaded later onto the handset 110. Updating the country database 308 may not be necessary since the laws like these tend to be rather static. However, updating the country database 308 is also possible. The updating could be done by the user of the handset 110 itself or alternatively automatic updates could be sent to the handset 110, for instance via a cellular network.

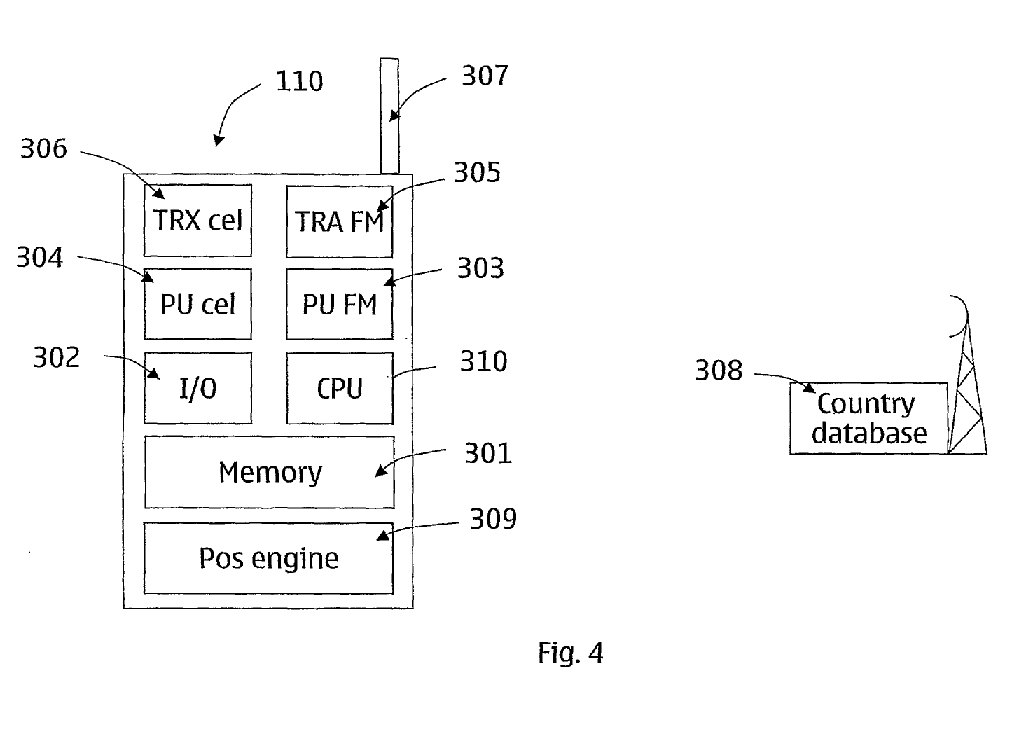

According to a second embodiment, the country database 308 is located in the network. FIG. 4 illustrates this embodiment. The handset 110 can then fetch the information about whether the FM transmissions are allowed or not over the air. This embodiment requires a specific central country database 308 where the country specific information is maintained. The country database 308 could be physically located, for instance, close to a home location register (HLR). Thus each network operator could have its own country database 308. Any other suitable location is of course possible. It may also be possible to only have one country database 308 for all users of the world. However, this would be better supported by internet protocol access. Whenever there is change in law, the country database 308 could be easily updated. The advantage is that the user of the handset 110 would always receive information, which is up-to-date.

According to a third embodiment, the location of the handset 110 in step 201 is determined by a network element, such as a base station. This embodiment is possible, since the base station knows the cell where the handset 110 is located. Accordingly there is no need for a positioning engine 309 in the handset 110. According to this embodiment the country database could be located either in the network or in the handset 110.

After the position of the handset 110 is detected at step 201, it is next determined whether the FM transmissions are allowed in this location. If the FM transmissions are allowed in this specific location, then the terminal can start the FM transmissions 203. If the user of the handset 110 indicates by using I/O means 302 that they want to start FM transmissions, then the PU FM 303 controls TX FM 305 and FM signals can now be transmitted.

However, if the FM transmissions are not allowed 204, then the PU FM 303 is informed that the FM transmissions are not permitted. Also the user of the handset 110 can be informed that FM transmissions are not permitted. In this case a specific message could be displayed on the screen of the handset 110. E.g. the following message could be displayed: “FM transmissions are not permitted in this area according to government legislation.” Of course any other suitable message could be displayed instead. This message could also be transmitted vocally or there could be a specific led flashing indicating that the FM transmissions are not allowed in the current location of the handset 110.

At step 205, the FM transmissions are disabled. However, this feature is optional. If the FM transmissions are not disabled, the onus of continuing or starting the FM transmissions is left to the user of the handset 110.

In case the handset 110 happens to be outside the coverage area of the cellular network or from some other reason the current location information is not available, information from the latest location of the handset 110 can be used in order to determine the location. There could also be an option that the user of the handset 110 could insert the country they are currently located by themselves. This option could be available when there is no cellular network coverage or location information from some other reason is not available.

The invention also relates to a corresponding software code, which can be used to implement at least some parts of the method according to the embodiments described above. The invention equally relates to a corresponding software program product in which a software code can be stored.

In the handset 110 all inventive features of this invention could be incorporated into a single module. According to the first embodiment, the module includes at least the country database 308 and the positioning engine 309. This module could also include at least one processor unit so that location related data could be processed. The module does not necessarily have to find the location itself, but instead it could control the procedure of finding the location.

The invention also relates to the handset 110, which comprises means for implementing the methods described above. According to the first embodiment, the handset 110 also comprises the module described above.

Finally the invention relates to a system where the handset 110 can be used. According to the second embodiment, the system comprises the country database 208 for identifying whether FM transmissions are allowed. Alternatively such a database could also be located in the handset 110.

It is to be noted that the described embodiments can be varied in many ways and that these are just exemplary embodiments of the invention.

1. A method for transmitting FM radio signals from a portable device the method comprising:
detecting the geographical location of the portable device; and
determining if FM transmissions are allowed or not in the detected geographical location.

2. The method according to claim 1, further comprising alerting the user whether FM transmissions are allowed or not in the detected geographical location.

3. The method according to claim 1, further comprising disabling FM transmissions if FM transmissions are not allowed in the detected geographical location.

4. The method according to claim 1, wherein said geographical location is detected by using one of the following positioning systems: GPS, Galileo, Glonass, and WLAN based.

5. The method according to claim 1, wherein said geographical location is detected by determining the identity of a cell of a cellular network in which the portable device is operating.

6. The method according to claim 1, wherein said geographical location is detected by determining a carrier code of cellular transmissions in a cellular network in which the portable device is operating.

7. A module for detecting whether FM transmissions are allowed, comprising:
means for detecting a geographical location of the portable device; and
a look-up table containing information on the allowability of FM transmissions in different geographical locations.

8. The module according to claim 7, further being incorporated in a portable device.

9. The portable device according to claim 8, further comprising an FM transmitter adapted to transmit FM signals.

10. The portable device according to claim 8, further comprising a processor for handling signals from at least one of the following: cellular communication network, satellite communication network.

11. The portable device according to claim 8, wherein said portable device is a mobile phone of a cellular communication system.

12. A system comprising:
a terminal operable to transmit FM signals, said terminal operable to detect the geographical location of the FM transmitter and determine whether FM transmissions are allowed in the current geographical location; and
a device operable to receive FM signals.

13. The system according to claim 12, wherein a country database for defining whether FM transmissions are allowed in the current location is located in a communication network.

14. The system according to claim 12, wherein a country database for defining whether FM transmissions are allowed in the current location is located in a terminal unit.

15. A computer-readable medium having encoded thereon a method comprising:
detecting the geographical location of the portable device; and
determining whether FM transmissions are allowed in the detected geographical location.

16. The computer-readable medium according to claim 15 wherein the method further comprises alerting the user whether FM transmissions are allowed in the detected geo graphical location.

17. The computer-readable medium according to claim 15, wherein the method further comprises disabling FM transmissions if FM transmissions are not allowed in the detected geographical location.
